(19) United States
(12) Patent Application Publication
(10) Pub. No.: US 2021/0142686 A1
(43) Pub. Date: May 13, 2021

(54) CHILD DEVELOPMENT AND TEACHER ACCOUNTABILITY SYSTEM AND METHOD

(71) Applicant: Karen Ross, Ft. Washington, MD (US)

(72) Inventor: Karen Ross, Ft. Washington, MD (US)

(21) Appl. No.: 17/093,494

(22) Filed: Nov. 9, 2020

Related U.S. Application Data
(60) Provisional application No. 62/931,876, filed on Nov. 7, 2019.

(51) Int. Cl. G09B 5/14; G09B 5/06

(52) U.S. Cl. CPC G09B 5/14; G09B 5/065

(57) ABSTRACT

A child development assessment, teacher accountability, and parental information system and method is described. The system employs a mobile device application which facilitates a process of informing parents of the progress of their children within a Montessori program structure while simultaneously providing an avenue by which teachers can convey real-time results of the child's progress in a given assigned task. Students are assigned a task in class, and teachers photograph the progress or end result of the task as completed by the students. The captured pictures are uploaded, and are accessible from the mobile device application by the parent/guardian of each student, providing a record of progress over time to the parent. Photos/video of the student's work are compared against mastery photos/videos present on a database.

### CONTINUITY

This application is a non-provisional patent application of provisional patent application No. 62/931,876, filed on Nov. 7, 2019, and priority is claimed thereto.

### FIELD OF THE PRESENT INVENTION

The present invention relates to the field of education, and more specifically relates to a system and method by which children are assessed according to Montessori tasks, and teachers are held accountable for the instruction of the tasks by which results are conveyed to parents/guardians via a mobile device application and/or browser-based application.

### BACKGROUND OF THE PRESENT INVENTION

It is known that children grow and develop at different rates. While development and learning are known to vary as children age, sometimes it can be difficult to measure progress over time, especially for parents or guardians. In early childhood development, the brain of the child does not often develop at a steady pace, but instead there are often great leaps of development from one age to another. Since the children are generally in school for much of their education, often parents do not see the progress of their children first hand, let alone in real time. If there were a way in which parents could be easily informed of the progress of their children based on a 4 level picture rubric which is an objective level of progress instead of a word rubric which could be construed differently from one educator to another, then parents would not need to visit the classroom, and parents and teachers would concur regarding the development of their children.

Similarly, for some parents it can be difficult to tell if their children have even completed any assignments, or if they have been assigned any educational tasks without personally visiting the classroom to view tangible work such as drawings and writings. This can be extra difficult for parents of preschoolers, as many of the tasks the preschoolers are assigned are performative, and therefore the product of the task is commonly put away, deconstructed, or taken down after completion (or attempt thereof). If there were a way in which the teacher could capture an image of the task/assignment prior to deconstruction, and the teacher could assign a level of progress based on a predetermined 4 level picture rubric, the level of progress pictures being assigned an assessment word based on how close the task/assignment came to being 100% correct, and a picture which exhibits 100% correctness, teachers could show parents the results of the assigned task to inform them of the progress of the student at given tasks over time.

Some educational staff do convey progress reports to parents, however they all lack photographic evidence rubrics for the child's performed task/assignments. Therefore, during parent/teacher conferences, subjectivity severs as the standard, and parents often leave the conference without knowledge of why their child received the grade/level of progress awarded. Instead, conventionally scores are generally conveyed via a paper report, email, and/or during the parent/teacher conference. If there were a way in which teachers could communicate progress to parents over a dedicated mobile device application, the process of informing parents of the progress of their children with a picture rubric system configured to match the closest resemblance of the child's photographic evidence (with either a Ai—Abstraction/Imagination score beyond 101 or more, Pr—standing for 100-90%, Or—standing for Orientation, 79%-70, Ex
standing for Exploration of 0-69%) would be facilitated and expedited.

Additionally, if there were a system which could hold teachers accountable for the lessons taught, as well as to provide proof of lessons grasped by the students, student transfers to other Montessori schools would be smoother, as there would be a record of the lessons and the student's progress from which the next school could continue. Therefore, when students, for reasons that present themselves, the photographic record, along with the photographic rubric, would be evidence that the Montessori environment may not be suitable for the student to thrive in a Montessori environment due to unbiased documented behaviors by teachers, school psychologists, or other school professionals and this evidence helps school system attorneys overturn least restrictive environment cases and thereby saving school systems millions of dollars from lawsuits. Moreover, the photographic record of the finished work, along with the 4-picture rubric as the true standard of how the student performed will help public Montessori schools stop students with no Montessori experience if they make the photographic record a new standard in accepting students in the program. Such a qualification will ensure that children that do not have the adequate Montessori experience are not admitted (which, for the primary level, ages 3-6 is needing at least one year of full time Montessori experience in an established class, and the lower elementary 6-9 needing 2 years of full time prior experience in a primary classroom, and three years of lower elementary 6-9 needs 2 years of full time prior experience in a primary classroom, three years of lower elementary full time experience 6-12). The only level that does not need prior experience are the infant and toddler programs. Therefore, when a student transfers to other Montessori schools, there would be a record that could give an objective view of the student's ability, and the new teacher could better plan lessons to continue the educational journey in Montessori education.

Thus, there is a need for a new child development reporting system and method configured to employ a mobile device application to convey progress of students to parents/guardians as it pertains to specific assigned tasks. Such a mobile device application is preferably designed to convey photographic evidence of a child's progress to parents quickly and easily, along with a timestamp, summary of the assignment, common core standard alignment, proficiency score of the child compared to and rated by the 4-level photographic rubric base (Montessori Level of Progress), time allocated for the assignment, child absence data, a video of the teacher demonstrating the concept, and other pertinent information. Actual Montessori manipulatives are provided to allow the child to use the manipulatives at home. A historical record of each child's progress over time is preferably provided which ideally aligns with Montessori guidelines. Parents/guardians may also opt to save the media-based evidence locally if desired for their own records.

### SUMMARY OF THE PRESENT INVENTION

The present invention is a child development tracking and reporting system and method for use by parents/guardians, teachers, teacher's assistances, and other educational staff. The system employs a mobile device application disposed in communication with a secured server computer accessible to both the school and parents of children attending the school. The mobile device application enables teachers to indicate progress of children in areas of targeted development and relay this progress to parents of the children. Progress is indicated via text and is preferably confirmed via the conveyance of photographic and/or video evidence of each child's results in the completion of a given assigned task.

After a task is assigned in class by the teacher, the student performs the task to the best of his/her ability. Upon (or near) completion of the task, the teacher captures photo(s) and/or a video of the child with the completed work in frame. The student's account (profile) to display and store his/her work is preferably associated with a fingerprint of the child for verification purposes. The captured media is uploaded to the secured server computer and is associated to a profile of the student. Then, the captured media is compared to a 4-picture rubric in the server of that activity and the computer matches the student's captured media. One level of progress is given based on the computer's matches to the closest replica of one of the picture rubrics. The captured media and the 4-picture rubric of that activity is put in the child's folder digitally in the area of work it is associated for a given subject area. Parents/guardians are alerted via a mobile device notification, indicating a new progress report is available. Then the parent/guardian may then log into the secured server computer via the mobile device application to ascertain the progress of their child in the given assigned task.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts an example screen of the mobile device application of the present invention as it pertains to detailing a child's progress at a given assigned task.

FIG. 2 depicts a flow chart detailing to process of use of the present invention by teachers, parents, and administration staff.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is a child development reporting system and method configured to inform parents/guardian's of their child's progress in a Montessori (or similar) school. The system employs a mobile device application (10) disposed in communication with a secured server computer which facilitates conveyance of developmental milestones to parents from teachers with visual (photographic and/or video) and auditory evidence of the progress of the child over time. The system and method of the present invention is geared to provide accountability for the teacher to both administration and parents. Reports (20) are generated based on feedback from the teacher for each assigned task for each student. The reports (20) may be used to both inform parents of progress, demonstrate mastery of concepts, and to provide proof of Montessori attendance of the child in the event that the child must move or otherwise be transferred to another Montessori school. Similarly, the present invention is designed to inform parents such that they may truly know if the Montessori program is working for their child, or if a different educational avenue should be pursued.

There are preferably four ratings provided for each assigned task in accordance with Montessori protocols. These ratings include:
1. Proficiency—(Pr)—child's picture of work done shows Order, Concentration, Repetition, Perfection/Exactness 100%.
2. Orientation—(Or)—child shows at least 70-99% of semblance of Proficient Level of Progress.
3. Exploration—(Ex)—child shows at least 0-69% of semblance of Proficient Level of Progress.
4. Abstraction/Imagination—(Ai)—has met Proficient level first and applies concept to real life situations in the class (101% or more).

To clarify per Montessori doctrine, the student may know how to do the work with 100% accuracy which is a “Pr” score. “Pr” stands for proficiency, but he or she may want to explore with the material which is developmentally appropriate for the education of young children. “Or” stands for Orientation and indicates the child is working on proficiency with the material but did not achieve it. “Pr” stands for Proficient and it shows that the child can do the lesson as presented in the lesson given by the teacher. “Ai” stands for Abstraction and Imagination of the work and this is given if the child starts to use the material abstractly through drawing it, writing about it, or talking about it. For instance, a child abstracted his lunch by saying the his green beans was Africa, his carrots was North America, his meatloaf was Australia, his strawberries was Europe, his whipped cream was Antarctica, his corn was Asia, his pink lemonade was South America based on colors indicated on a map of the world.

Once a student is tasked with an assignment, the student performs (or attempts to perform) the task. At or near completion, the teacher captures photo(s) and/or a video of the student and his/her work which is associated with a fingerprint of the student and then uploaded to the secured server computer. A Montessori Level of Progress (one of the above scores) rubric picture is assigned to the task by the computer with a default ability for the teacher to make the final decision based on other evidence documented, and the teacher indicates this score in association with the photo(s) and/or video captured. After the MLOP data is sent to the parent's phone (including a picture or short ending video of the child's work) the picture rubric is shown along-side the child's picture with a Level of Progress rating. Then, the grade or level of progress the child received based on the picture rubric is provided. The teacher preferably receives a message on the database to indicate that the message was sent. For example, a message may say “Dear parent, your child performed this work in the subject area of X, with the title of the material being X, and here is the level of progress earned as based on the picture rubric. Your child received a PR, etc. This video serves as his or her permanent record as indicated on this day and time. Based on this performance, the following At Home Activities are recommended: (two to three activities are the provided for the parent).” Before the child begins the activity in the classroom or at home, the teacher asks the student to sign-in to his or her profile via a fingerprint. The fingerprint then opens the child's account such that the picture would be automatically be stored solely in the account of that child.

A brief description of the assignment with common core standard is also preferably provided. Parents/guardians may then access the graded photo(s) and/or video, along with the MLOP rubric via the mobile device application, providing proof to the parent/guardian of progress of their child. If the child does not attempt the work at all, suggestions “At Home Activities” will be provided with marketed descriptions as provided by the manufacturer who have paid privileges to advertise.

The snapshot video or photo(s) of the child finishing the work is the proof that the assigned task was completed by their child (and not accidentally a different child in the class), and as such, the child is preferably in the video or photo(s) of the completed work. The teacher or assistant must observe the child while performing the task, and then at the end of the task time limit (or end of the day), the child and the work is captured on video/photo to show the child completing the work.

Upon upload of the evidence and text data pertaining to the assignment, the parent/guardian will receive a notification indicating a new picture/grade has been posted. In order to ensure that the image/video conveyed to the parent is authentic and current, a timestamp is preferably present for each image or video displaying the child and the completed work. The timestamps are helpful in showing progress over time as well. The timestamps preferably include the time, including hours, minutes, and seconds (hh/mm/ss), as well as the date (mm/dd/yy) to precisely indicate when the photo(s)/video was captured.

Information pertaining to the assignment (for example well-known pink tower assignment) is conveyed to parents so that they know what the ideal result is, which is also preferably conveyed via a stock photo indicating a perfect score (Pr). For example, the students are instructed on what to do for each assignment. A brief summary of this instruction is provided to the parent, such as below the picture of the end result, that explains to the parent what the instructions for the specific assignment are. Additionally, a brief description of what each lesson/task is trying to teach and to what Common Core standards the material relates is provided to the parent/guardian.

Parents are preferably afforded the option to easily save the images of the child's completed work directly to his/her device without taking a screenshot for their personal records via a dedicated save button. Similarly, the photo(s)/video are also preferably saved to a secured hosting server computer, providing a more accessible record of progress over time for each student.

In the preferred embodiment of the present invention, parents/guardians are provided the ability to change contact information, emergency contact information, indicate upcoming doctor's appointments, input a different name of a qualified adult allowed to pick-up the child from school, etc., from within the mobile device application. This information is accessible by school staff from within an administrator version of the mobile device application, which allows for the uploading of photos/videos of the student.

If a student is absent, due to COVID-19 or other serious illness, video lessons are preferably provided with consumables 2-D materials for students to complete lessons.

In order to sign up for the developmental progress reporting system and tool of the present invention, parents/guardians first fill out an enrollment form. Fields of the enrollment form preferably include, but are not limited to: “Parent/Guardian Name,” “Address,” “Email Address,” “Telephone Number,” “Credit Card Number,” (for billing purposes), a user-created username, and a user-created password. PayPal™ information or similar online payment mechanism may also be supplied with the enrollment form to facilitate payment for the services provided by the system of the present invention. Similarly, the enrollment form inquires of information pertaining to the student, including but not limited to: “Name of the Student,” “Name of the School,” “Name of Teacher,” “Date of Birth of Student,” “Age of Student,” and “Class,” (i.e. toddler, primary, lower elementary, upper elementary, etc.).

The process of use of the system and method of the present invention, as depicted in FIG. 2, is preferably as follows:
1. First, the parent fills out the enrollment form and creates a username and password to facilitate access to the mobile device application. (100)
2. Next, the parent/guardian downloads the mobile device application from a secured source (such as the Apple™ App Store, Google™ Play Store, or directly from the secured server computer. (110)
3. Then, the parent/guardian launches the mobile device application. (120) Alternately, the parent/guardian may receive a push notification, including an audio/visual alert indicating a new report is available for review, including a link to automatically launch the mobile device application. (125)
4. The mobile device application then displays a series of options to the parent/guardian, including: “calendar view,” “current assignment,” “user settings,” “rubric information,” “Suggested At Home Assignments,” among other options. (130)
5. Upon the parent/guardian selecting the “calendar view” or “current assignment” option, the parent/guardian is able to view current or past assignment results and scores, including photo(s) and/or video of their child completing the assignment. A brief explanation of the assignment, as well as an example of what a perfect score would look like are also displayed to the parent/guardian. (140)
6. A depiction of the Montessori evaluation rubric is also preferably available to the parent/guardian at any time within the mobile device application to assist the parent's comprehension of the evaluation criteria for a given assignment. (150) It should be noted that there is preferably a default feature available to enable teachers to record their own 4-picture rubric of an activity of any made-up activity that the teacher may create and become a part of the pre-established 4-picture rubric database. to do this, the teacher will layout the activity/task four different ways that represents MLOP. In short, to do this, the teacher will first writ ethe name of the activity in the database. Next, the teacher will input what lesson area to which the activity belongs (Practical Life, Language, Math, Cultural Areas, Geography/Biology/Zoology/Art/Music). When a student completes the lesson(s), the 4-picture rubric database of that new activity will ‘pop-up,’ and the teacher will give the assignment.
7. The parent/guardian may opt to save the report, including the photo(s) and/or video locally to his/her mobile device or computer. (160)
8. Parents/guardians may filter assignments according to Montessori categorization, including: Practical Life, Sensorial, Language, Math, or Cultural. Upon selection of a category of assignments, the selected category is preferably highlighted. (170)

It should be noted that the 4-level picture rubric database serves as a standard against subjectivity, lack of accountability, evidence of delay, evidence of learning challenges, evidence of giftedness, evidence of correct placement, evidence of teacher efficacy (or lack thereof), and evidence for winning legal cases in a court of law. Actually raw footage of the activity being performed by the child is intended to act as “the eyes of the parent.” As such, the child's utilization of the material provide insight into the nature of the child's strengths and weaknesses, and it serves as a formative assessment and summative assessment depending on the material.

The raw video is not edited by the system or the teacher as the raw data gives an accurate observation of child in all the areas to include, social, emotional, cognitive, and physical development. The only option available should be to erase an assignment, including the photographic/video proof of its completion, but that is solely reserved for teachers. This footage should serve as a legal record of the child's progress in the program.

It should be understood that the parent/guardian is encouraged to select the current class in which the student is studying, or any prior class the student has surpassed (i.e. Toddler (0-3), Primary (3-6), Lower Elementary (6-9), and Upper Elementary (9-12). Parent/guardians may also filter within each Montessori category. For example, selecting “Math,” the parent/guardian may then opt to view reports relating to specific math lessons including “Numeration/Counting,” “Decimal System,” “Memorization,” “Fractions,” “Money/Time,” and “Geometry.”

In some alternate embodiments of the present invention, Parents/guardians are afforded additional options pertaining to their children and their current status within the school. For example, parents/guardians may indicate upcoming doctor's appointments, excused leaves of absence, update emergency contact information for their children, and update names of whitelisted adults permitted to pick up the children from school.

Additionally, a section relating to “At Home Assignments” is preferably available for parents/guardians to review. Within this section, options and links are presented to parents/guardians relating to retail locations at which certain advised at home assignments may be purchased and/or performed online. It is envisioned that these retail links and teacher-posited at-home assignments are configured to help with the development of their child.

It should be noted that the video collection of the students' attempt at work will preferably show if the students are adapting to the Montessori learning environment. Similarly, the video collection will show if the children are misbehaving and not doing the work, and will show if the children cannot pay attention to a teacher giving a lesson. Likewise, the video collection is capable of depicting when children do not have the self-discipline to be in a Montessori environment to focus and perform their work independently. The videos are configured to show, over time, if the student is not achieving proficient scores and just keeps getting exploration scores (meaning they are far from the goal of proficiency) on that material in a certain area of Montessori (such as Math, etc.) which may indicate to parents that the Montessori program is not the best environment for their children.

In preferred embodiments of the present invention, the video database provides an average score at the end of each marking and shows the true level of Montessori progress for that child. Students' video portfolio is configured to show the quick progression of the students through the material because talented and gifted students catch on to learning very quickly and when they receive a proficiency score, they are ready to move to the next level of Montessori teaching and therefore, this will be reflected in the students' video portfolio. The video portfolio of a student will serve as evidence when a parent needs to petition for their child's entrance into a talented and gifted program to advance their learning. It is envisioned that this child's portfolio will show without doubt that when the child's scores “PR” (proficient) grades on the first try on the majority of assignments.

Additionally, as it pertains to the video portfolio of the student, it is envisioned that parents and teachers are provided with the ability to “freeze” and capture a screenshot, referenced as a “freeze-frame” of the video. Then, in association with the screenshot of the video, the parent or teacher may annotate the screenshot with text or drawing tools provided by the platform of the present invention to help further communication between the parent and the teacher. For example, the parent, upon review of the child's classroom work, may take a “freeze-frame” of the video, annotate it with questions asking how his/her child could do things better or differently, and then send the “freeze-frame” back to the teacher for further assessment and information.

It should be additionally noted that mobile device application (10) of the present invention preferably features a four-picture rubric and/or a four-blurb sound rubric for verbal testing which is performed by the teacher, generally referenced as the “Third Period” of a lesson. This third period is preferably available for each lesson in all the areas of Montessori to include Practical Life, Sensorial, Language, Math, and Cultural, and is present to compare with the finished work assignment of the student. This allows for the parent to see why the teacher gave the progress grade for the given assignment to the student.

Further, it should be noted that the system and method of the present invention provides the world's first multi-picture rubric database of materials of the Montessori materials, ranging from infant to age 12, which can be matched to Montessori Levels of Progress. With this system, parents can now see what the symbols mean in terms of how their child is developing based on their personal view of the material because of the photographic evidence providing an objective standard. As such, the picture database is critical to the functionality of the present invention, as it provides an objective standard against which the student's work/performance may be compared via photographic and/or video-based proof of the child's work.

In some embodiments of the present invention, parents are afforded the option to comment on specific portions of a video and send their feedback with a clip of that video back to the teacher for further input, clarification, or other information pertaining to the student's performance. Similarly, in some embodiments of the present invention, parents may upload a video of the student performing the task/assignment at home, and match it to a portion of a model video to show the teacher that they have helped their student to master something in the home as may be required during the COVID-19 pandemic. In such instances, the teacher may then comment if the video of the child performing the task/activity at home matches the “ideal” performance video model from the picture/video database of the present invention. Comparing the student's uploaded video (as uploaded by the parent) vs. the video segment within the database, the teacher may then discern whether the child has achieved mastery in the task at home.

Additionally, it should be noted that some preferred embodiments of the present invention are preferably equipped with a translation feature which would facilitate communication between the parent and the teacher in the native language of the parent as needed. The translation feature ultimately displays English words as well as the native language of the student/parent. It is envisioned that an audio feature may be present to enable the commentary and scores to be read-aloud to the parent via the platform of the present invention. It is similarly envisioned that Braille lessons be made available via the platform to assist students who are blind.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A method for facilitating the educational development of a child while maintaining accountability of a teacher in a Montessori environment comprising:
creating a user account for the child on a internet-connected platform, the platform disposed in communication with an image database;
the child performing an activity as an assignment;
the child completing the activity, providing a tangible output;
a digital camera capturing at least one image of the output;
the at least one image being associated with the user account of the child, and saved in association with the account of the child;
a computer comparing the at least one image against an ideal image which demonstrates mastery of the activity;
the computer assigning a score to the output based on Montessori Levels of Progress in accordance with a specific category as a direct result of comparing the at least one image against the ideal image;
the teacher confirming the score assigned;
the teacher correcting the score if necessary; and
the computer saving the score to the account of the student, providing a history of the child's progress and accomplishments.

2. The method of claim 1, further comprising:
a parent of the child accessing the user account;
the computer providing access to the parent to review the progress of the child via the at least one photo of the child's activity;
the computer showing the parent the ideal image which demonstrates mastery of the activity; and
the computer positing assignments for the child to perform at home to aide in the mastery of the child in the assigned activity.

3. The method of claim 2, further comprising:
the computer capturing at least one image of the child's work at home;
uploading the at least one image of the child's work at home to a database associated with the user account of the child;
the teacher viewing the at least one image; and
the computer providing a field in which the teacher may communicate assistance to the parent and child via the platform.

4. The method of claim 1, wherein the platform is a mobile device application.

5. The method of claim 1, wherein the at least one image is a video.

6. The method of claim 1, wherein the image indicating mastery is one of four parts of a Montessori evaluation rubric.

7. The method of claim 2, wherein the image indicating mastery is one of four parts of a Montessori evaluation rubric.

8. The method of claim 3, wherein the at least one image is a video.

9. The method of claim 3, wherein the platform is a mobile device application.

10. The method of claim 3, wherein the image indicating mastery is one of four parts of a Montessori evaluation rubric.
